(19) United States
(12) Patent Application Publication
(10) Pub. No.: US 2003/0053045 A1
(43) Pub. Date: Mar. 20, 2003

(54) System for inspecting a flat sheet workpiece

(76) Inventor: John W. Doering, Tustin, CA (US)

Correspondence Address: JOHN W. DOERING, 14332 KIPLING LANE, TUSTIN, CA, 92780-5743, US

(21) Appl. No.: 09/960,036

(22) Filed: Sep. 20, 2001

(51) Int. Cl. G01N 21/88

(52) U.S. Cl. 356/237.1

(57) ABSTRACT

An inspection system for automatically scanning, documenting and verifying the perimeters and hole dimensions of flat sheet metal workpieces.

The system includes an inspection table with a transparent surface upon which a workpiece is placed. A servomotor controlled rack and pinion gear driven carriage, which travels along the table on rails in the X direction. The carriage consists of a shelf above the table containing a fluorescent tube lamp for back illuminating the flat sheet part, and a shelf below the table surface containing an optical/sensor imaging array module which travels on rails cross the width of the carriage in the Y direction servo driven via a ball screw drive. The optical sensor imaging array is responsive to light energy, detecting and processing light-to-dark and dark-to-light transitions as it scans across the workpiece, the scan transition addresses being representative of the location of the edges of the perimeter and holes of the workpiece. The X and Y-axis transition edge data is processed and stored in a microcomputer for subsequent processing, display, and print out.

### BACKGROUND OF THE INVENTION

1. Field of the Invention

This invention relates generally to an automatic high-speed electro-optical scanning inspection system, and more particularly, to a system including an unique inspection table, movable carriage, optical assembly and a light sensitive array which is adapted to automatically scan, verify, measure and document the perimeters and holes formed in a fabricated flat sheet metal workpiece.

2. Prior Art

It is common practice to manually inspect punched, flat sheet metal parts using scales, calibers, micrometers or other manual instruments. Complex workpieces with complex shapes and/or a multitude of holes becomes laborious, time consuming and highly subject to human error.

Accordingly, automatic electro-optical inspection systems have been developed to increase efficiency, accuracy and reduce the costs of inspection. However, such automatic systems usually involve the X and Y axis movement of the workpiece or light sensor, reading out the coordinate of each edge crossing as it passes by the center of the sensor. Such systems are generally very slow and expensive.

Another example of prior art is a system-employing array multiple linear sensors as described in U.S. Pat. No. 4,711,579, dated Dec. 8, 1987 to Blair E. Wilkinson. This system consists of a transparent table surface, with a yoke, which moves, in one axis along the table. It employs a plurality of linear sensor CCD arrays (five or more), arranged to form a continuous line of optically aligned CCD sensor arrays arranged to electrically scan across the width of the table. Typically each sensor array consists of a single row of 2048 or more sensor elements. These arrays are mounted onto a yoke, which is mechanically moved in one-axis perpendicular to the direction of array scan. The accuracy of this invention is dependent upon the number of CCD sensor arrays employed. In viewing a typical 48 inch wide scanning format a minimum of eight and preferably sixteen overlapping optical sensor arrays would required to approach the accuracies required by the sheet metal industry. The accuracy of this invention is also very dependent upon the workpiece being close to a perfect part, i.e. essentially flat, with sharp vertical walled edges and holes. However, the vast majority of sheet metal parts in the industry are sheared, punched, laser cut and waterjet cut typically resulting in a workpiece that is slightly bowed, with rounded edges and holes due to tool impact and breakout (hole burst and/or burrs). Tool impact imperfections vary with the type of material, material handling and tools applied. Some workpieces are fabricated with countersunk and dimpled holes. The accuracy of the Wilkinson invention can be significantly degraded by these edge variations because of the angular field-of-view inherent in the systems optics. Holes smaller in diameter then the thickness of the fabricated part may not be detectable. The transparent glass/plastic table top cannot be maintained in flat horizontal plane over a large area (as it bows towards the center) and the workpiece will typically lie in a plane above or below the plane of scale calibration. This may be compensated for by overlapping the field-of-views so that each edge is viewed by two optical sensor arrays.

Such a system is generally expensive, and requires a very precise and difficult to achieve alignment of the sensors and their optics.

Another example of prior art is a system employing a time delay and integration charged coupled device sensor and curved mirror optics as described in U.S. Pat. No. 5,184,217 dated Feb. 2, 1993 to this inventor John W. Doering. The present system comprises a transparent glass topped inspection table upon which a workpiece is placed. A rack and pinion gear driven carriage is mounted on rails, and servo driven in the X direction across the length of the table, the carriage includes oppositely aligned horizontal top and bottom shelves, the top shelf supporting a fluorescent lamp, which illuminates the table surface in a line in the Y-direction across the width of the table. The bottom shelf contains an optical sensor module, which is mounted on rails, and servo driven for positioning in the Y direction. Electrical mechanical X and Y-axis positioning are readout by two-phase rotary optical encoders. The optical sensor module consists of a single two-dimensional charged coupled device (CCD) imaging sensor with an optical system consisting of a lens, two flat mirrors and a curved mirror. The mirrors provide for the folding of optical path to minimize the length of the optical sensor module and to enhance the use of a long focal length lens. The curved mirror is curved into two axes (X and Y-directions) to bend the light path so that each element of the two-dimensional sensor array is viewing the workpiece from a vertical angle, essentially eliminating the effects of edge imperfections (tool impact), countersunk or dimpled holes, and variations in workpiece thickness. The curved mirror optics is relatively expensive and it generates a non-linear X and Y-axis scanning format requiring a complex optical setup and complex two-dimensional non-linear data correction.

The present invention employs an improved optical design, which is less expensive and significantly easier to align and calibrate. All of its sensor elements view perpendicular to the workpiece, essentially eliminating the effects of edge imperfections (tool impact), countersunk or dimpled holes, and variations in workpiece thickness.

Other examples of known systems for inspecting flat sheet metal workpieces are available in one or more of the following United States Patents:

U.S. Pat. No. 2,684,009 Jul. 20, 1954

U.S. Pat. No. 4,319,272 Mar. 9, 1982

U.S. Pat. No. 4,555,798 Nov. 26, 1985

U.S. Pat. No. 4,560,273 Dec. 24, 1985

U.S. Pat. No. 4,573,798 Mar. 4, 1986

U.S. Pat. No. 4,783,826 Nov. 8, 1988

U.S. Pat. No. 5,231,675 Jul. 27, 1993

### SUMMARY OF THE INVENTION

Briefly, and in general terms, a high performance inspection is disclosed for automatically inspecting, documenting and verifying the position of the dimensions of the perimeters and holes formed in a punched, drilled, stamped, waterjet or laser cut flat sheet metal workpiece. The present system provides an accurate, high speed and cost effective improvement over the time consuming and error prone techniques, which have heretofore been used, for inspecting flat parts.

The present system comprises a transparent glass topped inspection table upon which a fabricated flat workpiece (part) is placed. A carriage is mounted on rails, and servo motor driven in the X direction across the length of the table, The carriage includes oppositely aligned horizontal top and bottom shelves, the top shelf supporting a fluorescent lamp which illuminates the table surface in a line in the Y-direction across the width of the table. The bottom shelf contains an optical sensor module, which is mounted on rails, and servomotor driven for positioning in the Y direction. The optical sensor module consists of a Charge coupled Device (CCD)camera, and an optical system consisting of a multiple element enlarging lens, a flat mirror and a plano-convex field lens. The mirror provides for the folding of optical path to minimize the length of the optical sensor module and to enhance the use of a long focal length enlarging lens. The effective focal length of the plano-convex lens and the front node of the enlarging lens are aligned so that each element of the two-dimensional sensor array is viewing the fabricated part from a vertical angle, essentially eliminating the effects of edge imperfections (tool impact), countersunk or dimpled holes, and variations in workpiece thickness.

The CCD Camera contains a time delay integration (TDI) two-dimensional area array CCD imaging sensor, consisting of multiple sensor elements per row (Y-Axis), and multiple rows (X-Axis). It is clocked and synchronized to match the rate of carriage movement in the X-Axis direction.

The sensor and its optics are aligned and calibrated by scanning a precision glass scale located in the surface at one end of the table. The X and Y-axis servo motor drives are programmed and controlled so that the optical sensor module scans the surface of the table in the X-direction in multiple scan passes, each overlapping the proceeding scan by one percent.

The CCD Camera outputs digital video, pixel clock (strobe), and line valid signals from the optical sensor module interfaces with the Edge Data Processor, which mounts into a plug-in circuit board slot in a standard personal computer. The Edge Data Processor compares the multi-gray level digital video data from the camera and converts the data into white-to-black and black-to-white point edge transition position Y-axis counts (run-length edge count) which is entered into a first-in-first-out (FIFO) memory.

The position of the carriage in the X-direction is readout by a linear encoder, which drives clocks a counter in the Video Data Processor. The counter is configured as a closed loop divider outputting line scan synchronizing pulses to the camera, timed so that successive camera scans view the same area in a line-by-line sequential format, with the photon charge of the sensor elements in each row adding to the next to increase sensor sensitivity. The run length X-count of each is entered into a first-in-first-out (FIFO) buffer memory. At the beginning of each scan line, a bit is entered in the data stream, which is counted within the computer to determine X-axis position. The end of scan signal (line valid) or a FIFO half full sets a computer interrupt, and the edge and X-axis position data is read out of the FIFO by the computer and entered into computer memory for software processing. The sensor picture element (pixel) data edge transition counts (X-Axis) and Y-axis sensor position counts determine the address location of points on the perimeter and hole edges of the workpiece. The resulting data is software processed for scaling, measurement and comparison computations, display, printout and plotting.

### DESCRIPTION OF THE DRAWINGS

Preferred exemplary embodiments of the present invention will hereinafter be described in conjunction with the appended drawings wherein like designations denote like elements, and;

FIG. 1 is a perspective view showing the automatic inspection system, which forms the present invention;

FIG. 2 is a diagram describing the mechanical components of the two axes of motion control for positioning the optical/sensor module;

FIG. 3 is an overall functional block diagram of the inspection system's electronics, which forms the present invention;

FIG. 4 is a perspective diagram describing the mechanical components of the optical sensor module.

FIG. 5 is a perspective diagram describing the functional diagram of the optical sensor module optics, and

### DESCRIPTION OF THE PREFERRED EMBODIMENT

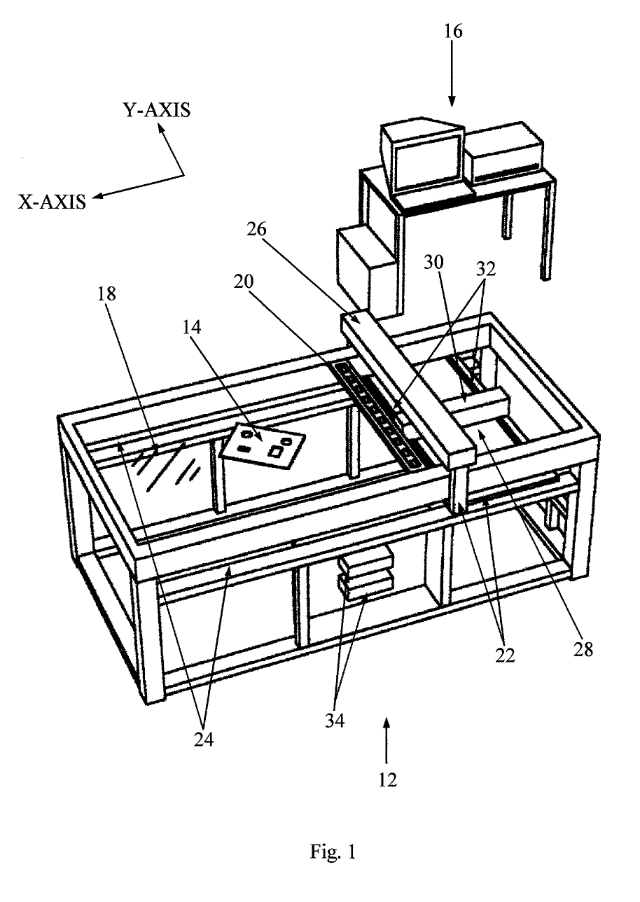

The automatic inspection system of the present invention for sensing and measuring the position of the perimeters and the location and dimensions of holes in a metal part are best described while referring to the drawings. In FIG. 1, there is an inspection table 12 upon which a workpiece 14 is placed. The inspection table and computer workstation 16 functions as the mounting locations for all of the soon-to-be-described components of the system. By way of example only, the inspection table is fabricated with a steel core, supported by an extruded aluminum frame. The table can be configured in a variety of sizes, for scanning up to 54-inches by 94-inches. The table has a typical working height of 28-inches, and an overall height of 36-inches. The steel core is precision machine and stress relieved so that is temperature stable over a wide range of operating environments.

The top of the table contains an optically quality transparent flat sheet of plastic laminated high strength safety glass 18, chemically hardened to resist abrasion and scratching. A precision calibration scale 20, consisting of a pattern of graduated markings etched in black on a transparent optical quality flat glass plate is located at one end of the table. It is scanned by the CCD camera sensor to provide video edge data, which is software processed to align and automatically calibrate (scale) the data in the Y-axis direction for each scan pass.

The table includes a carriage 22 which is mounted on precision rails 24, and positioned in the X-axis direction by a servo motor module via a rack and pinion gear interface. The carriage has two shelves, the upper shelf 26 containing a fluorescent lamp which illuminates the top of the table surface, and the bottom shelf 28 containing an optical sensor module 30 which views the bottom of the table surface. The optical sensor module is mounted on rails 32 on the bottom shelf and positioned in the Y-axis direction by a servo motor module via a pre-loaded ball screw drive.

Upon applying power, the optical sensor module 30 and the carriage 22 are driven to a home end position at one corner of the table (established by limit switches), which serves as the referenced origin for movement in the X-axis direction (first direction) and Y-axis direction (second direction). The carriage 22 scans down the length of the table in the X-axis direction, and as it returns the optical sensor module 30 is incremented 3.65 inches to an adjacent position so that its field-of-view overlaps the previous scan by about one to ten percent; the carriage 22 repeats its scan pass down the table; repeating until the table top area has been scanned. If the workpiece 14 is placed near the home position, the system can be software setup to scan only the workpiece, or a predetermined area of the table to reduce scanning time.

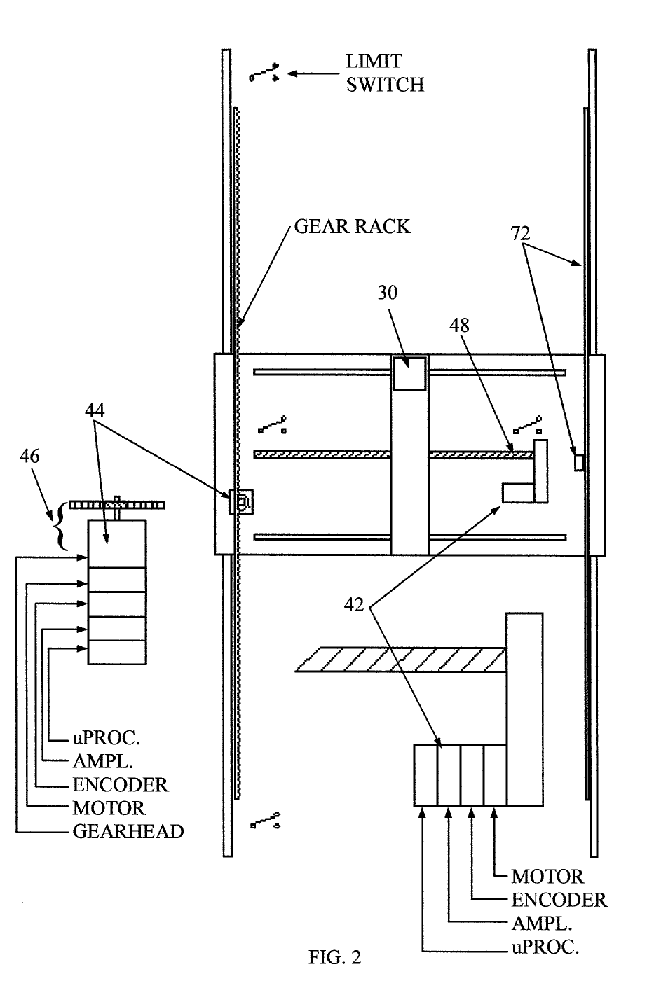

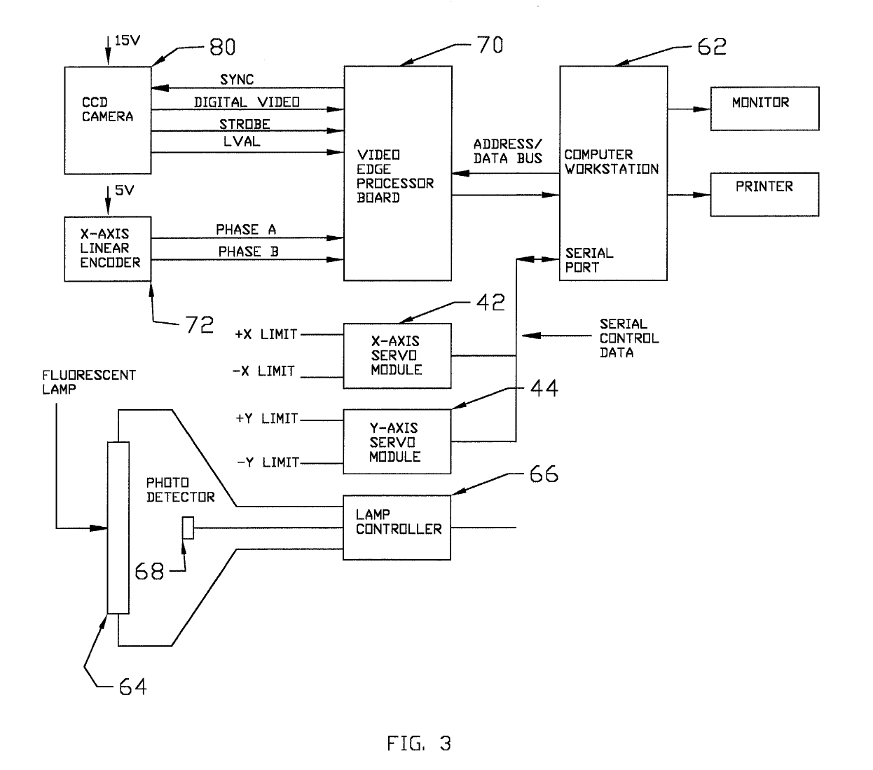

Each servo motor module 42 and 44 (FIG. 2) is a closed loop servo system, consisting of a built-in microprocessor, rotary shaft encoder, power amplifier and motor enclosed with a single enclosure. The microprocessor contained within each servo motor module is pre-programmed to respond to function with pre-set ramp up, rate, positioning and ramp down sequences as commanded by system's microcomputer. A DC Power supply located in an enclosure 34 on the side of the table powers the servomotors. The X-axis servo motor module 42 positions the carriage 22 via a reduction gearhead; pinion gear and gear rack drive mechanism 46. The Y-axis servo motor module positions the optical/sensor module 30 (FIG. 2) via a pre-loaded ball screw drive mechanism 48. The servo motor modules 42 and 44 (FIG. 3) are controlled via a standard RS232 or RS485 serial port interface with the system's microcomputer 62 (FIG. 3).

A very high output fluorescent lamp 64 (FIG. 3) on the upper shelf 26 (FIG. 1) illuminates the top of the table and the workpiece 14. The lamp is driven by a regulated high frequency closed loop lamp controller power supply 66 (FIG. 3) on the underside of the bottom shelf 28 (FIG. 1). A photodiode light sensor 68 (FIG. 3) feedback into the controller maintains a relatively constant level of high intensity illumination. The lamp is mounted so as to be in opposite alignment with the optical port of the optical/sensor module 30.

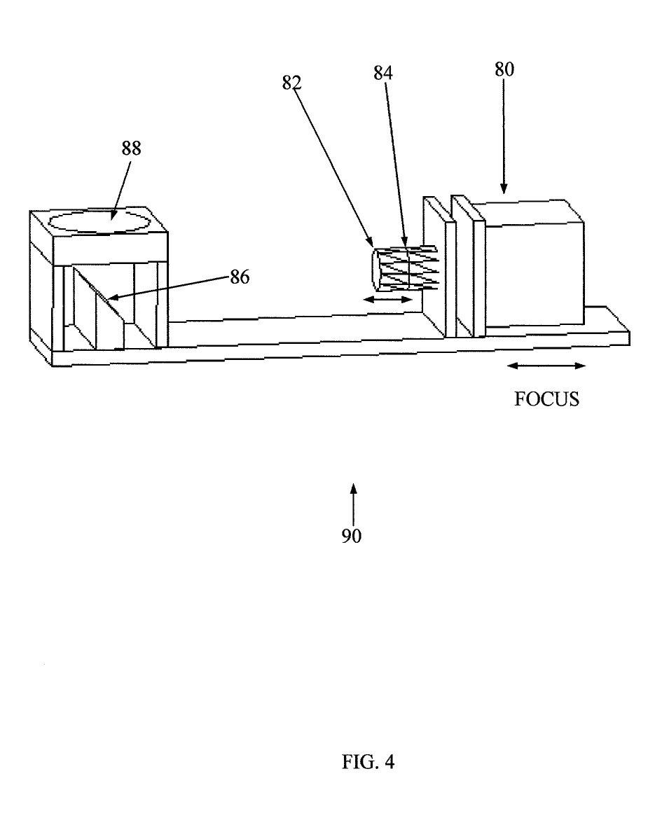

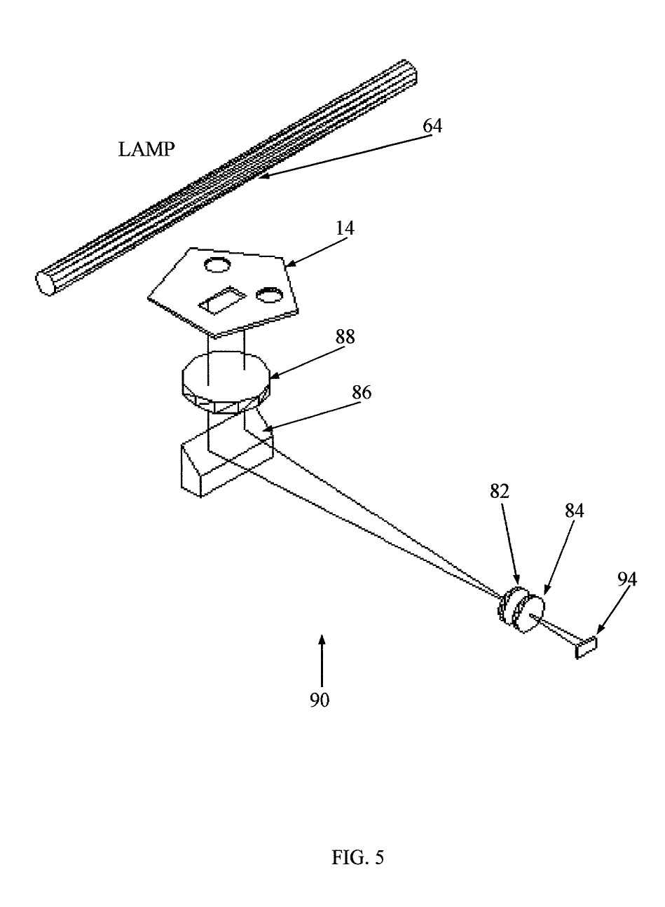

The optical sensor module 90 described by FIGS. 4 and 5 consists of a charge coupled device (CCD) camera 80, a 80 millimeter focal length multiple-element enlarging lens 82 with an iris aperture of f#22 to f#32, a visible long wave pass edge filter 84, a flat mirror 86 and a large Plano-Convex Lens 88. The optics are aligned and positioned so that the array is focused to view a workpiece 14 (FIG. 5) placed on the transparent surface of the table, which is back illuminated by the a fluorescent lamp 64 which has an illumination output in the cool white color spectrum. The long wave pass edge filter 84 passes the color spectrum above the wavelength of 450 nanometers. The mirror 86 provides for the folding of optical path to minimize the length of the optical sensor module and to enhance the use of a long focal length lenses. The effective focal length of the plano-convex lens 88 and the front node of the enlarging lens 82 are aligned so that each photo sensitive element of the two-dimensional sensor array is viewing the fabricated part at an angle perpendicular to the surface of the table, essentially eliminating the effects of edge imperfections (tool impact), countersunk or dimpled holes, and variations in workpiece thickness.

The enlarging lens 82 is mounted on an adjustable telescoping tube, which provides for the precision setup of the enlarging lens to plano-convex lens 88 spacing. The CCD camera 80 is mounted on a precision positioning slide, which provides for precisely setup of the field of view and focus at the table surface. The system is typically setup for achieving a ±0.002-inch measurement resolution with greater than a 0.5-inch depth of focus.

The optical mounting components and the carriage for optical stability are fabricated from precision cast tool and jig aluminum plate, which is highly stable, aged, stress relieved and ground to precision tolerances.

FIG. 3 describes an overview of the electronic imaging components of the system. The CCD camera 80 interfaces with the video edge processor circuit board 70, which is installed in the system microcomputer 62. The CCD camera's imaging sensor 90 (FIG. 5) is a time delay and integration (TDI) two-dimensional area array imaging sensor, which provides for approximately eighty times greater sensitivity than a single line linear array sensor. The CCD imaging sensor 90 consists of 96 rows (X-axis) of 2048 photosensitive elements (Y-axis) configured into a Time Delay Integration (TDI) mode of operation. By way of example, a suitable CCD sensor for use herein is the Type IT-E1-2048 Two Dimensional Sensor manufactured by Dalsa, Inc. Waterloo, Ontario, Canada.

The CCD imaging sensor module is aligned so that the 2048 CCD element rows are aligned in the Y-axis direction. As the sensor is moved to scan the table surface in the X-axis direction, the photon charge (image data) accumulated in each row of 2048 elements is transferred in parallel in the X-axis direction from row to row, in a scrolling format, to an analog shift register, interfacing with an analog-to-digital converter to output an 8-bit digital video signal, a active scan line enable and a picture element (pixel) clock to the digital video edge processor board 70 (FIG. 3).

The digital video edge processor board 70 is a circuit board, which mounts into a standard commercially available high-speed personal computer 62, IBM or IBM compatible personal type. The video edge processor compares and processes the digital video signal input into a one-bit edge transition run length encoded format which is address encoded into a edge point file of the scanned image. The file is buffered through a FIFO memory into the main microprocessor bus and its memory for software data processing.

A precision linear optical or magnetic encoder 72 (FIGS. 2 and 3) mounted on the side of the table with a readhead on the carriage provides a two phase carriage X-axis position signal output which is processed by the digital video edge processor board 70 to provide a line scan synchronizing signal input to the CCD imaging sensor module. The linear encoder has readout clock accuracy of 5 uM (0.000195685 inch) which is divided by ten to provide a sensor synchronizing spacing of 50 uM (0.00195685 inch) which corresponds to a scan line density of 508 scans per inch, with the image moving across the imaging plane at the same rate as the signal charge is being transferred from row-to-row.

In a non-scanning setup mode the video edge processor board can be commanded to output a synchronizing signal at the normal scanning rate to the CCD imaging sensor for system alignment. The optical sensor module is aligned viewing the edges of a large precision 90-degree angle to setup the precision edge glass scale 20 (FIG. 1) so that it is perpendicular to the carriage travel.

In the scanning processes the modular optical/sensor assembly views over the precision etched glass scale 20 at the start of each scan. The image of glass scale provides for the precise scaling of the point image data in the Y-Axis, while the precision linear encoder synchronized line scans scales the edge data in the X-axis.

The computer is configured with a high capacity virtual RAM disk and high capacity hard disk drive for high-speed data manipulation and computation. The computer is a part of a computer workstation, which includes peripheral components consisting a large video data display monitor and a printer for hardcopy data print out.

Software provides for control of scanning motion, and for the computation and processing of edge point data. The processing software with a DXF Computer Aided Design (CAD) File interface provides for the comparison of the scanned workpiece edge data with its master CAD file for first article validation and for in-process inspection, within pre-selected tolerances displayed on the video display monitor, or an image or tabular report printout via the printer. The software can be configured to provide for reverse engineering, generating a dimensional CAD drawing file of the workpiece 14 (FIG. 1), for duplicating, modifying or comparison of a workpiece.

By virtue of the present invention, an economical high speed, highly accurate inspection system is available for documenting and verify on a CRT screen, graphic printer, column printer and/or X/Y plotter, the perimeter and hole dimensions of a flat workpiece. The present system is a fully automatic and non-contact measuring scanning system, requiring no operator setup time thereby providing a significant savings of time compared with the traditional and time consuming approach of physical contact measurements using calibers, gages, tape measure and/or X/Y coordinate mechanizations. It can accurately measure sheared, punched, drilled and laser cut s with rounded edges, and countersunk and dimpled holes. It establishes a measurement grid of five hundred pixels per inch in both axes, i.e. a measurement accuracy of ±0.001-inch. Unlike many of these systems, the workpiece remains stationary and only the carriage is moved in the X-axis direction and the optical/sensor array module is moved in the Y-axis direction. This avoids the relatively complex prior art inspection process of rotating and/or moving the workpiece in two directions manually or by motors. The present system utilizes an optical design that provides for a non-contact vertical (perpendicular) optical alignment of the elements of a single sensor imaging CCD array in viewing a typical workpiece, thereby providing a significant improvement in accuracy over non-contact systems employing a plurality linear array sensors in a non-perpendicular optical viewing alignment.

It will be apparent that while a preferred embodiment of the invention has been presented for the purpose of illustration and description. It is not intended to be exhaustive or to limit the invention to the precise form disclosed. Many modifications and variations are possible in light of the above teaching. It is intended that the scope of the invention be limited not by this detail description, but rather by the claims appended hereto. For example, although the present inspection system has been described with reference to the perimeter and holes in a flat sheet metal, it is to be understood the present system has application for documenting and verifying the perimeter and holes made in any opaque or semi-opaque workpiece regardless of composition. It is also to be understood that the present system can configured without departing from the true spirit and scope of the invention with other open-loop and closed loop motion control positioning drives; with or without the flat surface mirror or long pass filter; or with a plano-convex or an achromatic lens.

Having set forth a preferred embodiment of the present invention, what is claimed is:

1. A system for automatically inspecting a workpiece for the perimeter and holes formed therein, said system comprising of:
an inspection table having a transparent glass surface upon which the workpiece is to be laid;
an etched glass calibration scale located at the edge of the glass surface of the table for sensor scale calibration;
a carriage mounted on rails on the table, which is movable in a first direction; containing a light source, and an optical sensor module, which is movable in a second direction perpendicular to the first;
a CCD camera with an imaging sensor consisting of plurality of CCD photo sensing elements, and an optical configuration situated within said optical sensor module;
a computer workstation interfacing with motion control positioning subsystems, providing computer controlled two-axis motion control positioning of the carriage in one direction and the optical sensor module in a second direction perpendicular to the first;
a video edge processor board situated within said computer providing the means for synchronizing the CCD camera and the processing of edge address data computer processing;
Wherein the optics within the optical sensor module are configured to align the viewing angle of each photo-sensing element of the multiple element sensors so that they are perpendicular to and focused at or above the surface of the transparent table top.

2. The inspection system recited in claim 1, wherein then carriage is mounted on rails and movable in the first direction, by a motor driven mechanical drive with optical encoder position feedback, controlled by a motion controller in a closed loop servo configuration.

3. The carriage recited in claim 2, wherein the carriage is comprised of an upper shelf containing a fluorescent lamp and a lower shelf with an optical sensor module mounted onto rails and movable in the second direction by motor mechanical driven drive with an optical encoder feedback, controlled by the motion controller in a closed loop servo configuration.

4. The carriage recited in claim 3, wherein the fluorescent lamp is positioned above the transparent glass table surface in an opposing alignment with the optical sensor module below the surface, illuminating the optical port of the optical sensor module around the perimeters and through holes of the workpiece over its travel in the second direction.

5. The inspection systems recited in claim 1, wherein the imaging sensor contained with the CCD camera is a time delay integration charged coupled device; comprised of a plurality of rows and columns of photo sensing elements, with the rows aligned perpendicular to the first direction; wherein the motion of the carriage in the first direction is synchronized with the scanning of the imaging sensor so that as the image passes each row of sensor elements, the signal charge generated in the sensor is passed from one row to the next row, with the signals being summed over the plurality of rows before being transferred to a readout shift register; and providing an indication of the location of the edges of the perimeter and holes in the workpiece, relative to the location of the optical sensor and its photo sensing elements as it scans the on the table surface.

6. The inspection system recited in claim 1, wherein the optical sensor module is configured in an optical arrangement comprised of the imaging sensor, an enlarging lens; a mirror to fold the optical path to achieve a compact module, and a plano-convex lens. Wherein the front nodal point of the enlarging lens is positioned at the effective focal point of the plano-convex lens to aligned the viewing angle of each photo sensing element of the multiple element sensor is perpendicular to the surface of the table and the workpiece.

7. The inspection system recited in claim 1, wherein the CCD camera is comprised of the circuitry for timing and synchronization, analog to digital video conversion, and interfacing with the CCD sensor and edge data processor board.

8. The inspection system recited in claim 1, wherein the computer workstation is comprised of a computer for data interfacing, processing and storage; plug-in circuit board slots; and software for data manipulation, measurement and comparison computations; and computer peripherals for data display and printing.

9. The inspection system recited in claim 1, wherein the edge data processor board plugs into the computer and is comprised of circuitry for interfacing with the clock, timing and digital video signals from the CCD camera, bi-phase signal from the X-axis linear encoder; and run length encoding of edge addresses and end of line into a first-in-first-out memory for buffering the data onto the computer data bus.

10. A system for automatically inspecting a workpiece for the perimeter and holes formed therein, said system comprising of:
an inspection table having a transparent glass surface upon which the workpiece is to be laid;
an etched glass calibration scale located at the edge of the glass surface of the table for sensor scale calibration;
a carriage mounted on rails on the table, which is movable in a first direction; containing a light source, and an optical sensor module, which is movable in a second direction perpendicular to the first;
a CCD camera with an imaging sensor consisting of a plurality of CCD photo sensing elements in rows and columns, an enlarging lens, and a plano-convex lens situated within said optical sensor module;
a computer workstation interfacing with motion control positioning subsystems, providing computer controlled two-axis motion control positioning of the carriage in one direction and the optical sensor module in a second direction perpendicular to the first; and a video edge processor board
a video edge processor board situated within said computer providing the means for synchronizing the CCD camera and the processing of edge address data computer processing;
Wherein the front nodal point of the enlarging lens is positioned at the effective focal point of the plano-convex lens and the positioning of CCD sensor is to align the viewing angle of each photo-sensing element of the multiple element sensor is perpendicular to the surface of the table and the workpiece.

11. The inspection system recited in claim 1, wherein the carriage is mounted on rails and movable in the first direction, by a motor driven mechanical drive with optical encoder position feedback, controlled by a motion controller in a closed loop servo configuration.

12. The carriage recited in claim 11, wherein the carriage is comprised of an upper shelf containing a fluorescent lamp; and a lower shelf with an optical sensor module mounted onto rails and movable in the second direction by motor mechanical driven drive with an optical encoder feedback, controlled by the motion controller in a closed loop servo configuration.

13. The carriage recited in claim 12, wherein the fluorescent lamp is positioned above the transparent glass table surface in an opposing alignment with the optical sensor module below the surface, illuminating the optical port of the optical sensor module around the perimeters and through holes of the workpiece over its travel in the second direction.

14. The inspection systems recited in claim 10, wherein the imaging sensor contained with the CCD camera is a time delay integration charged coupled device; comprised of a plurality of rows and columns of photo sensing elements, with the rows aligned perpendicular to the first direction; wherein the motion of the carriage in the first direction is synchronized with the scanning of the imaging sensor so that as the image passes each row of sensor elements, the signal charge generated in the sensor is passed from one row to the next row, with the signals being summed over the plurality of rows before being transferred to a readout shift register; and providing an indication of the location of the edges of the perimeter and holes in the workpiece, relative to the location of the optical sensor and its photo sensing elements as it scans the on the table surface.

15. The inspection system recited in claim 1, wherein the CCD camera is comprised of the circuitry for timing and synchronization, analog to digital video conversion, and interfacing with the CCD sensor and edge data processor board.

16. The inspection system recited in claim 10, wherein the computer workstation is comprised of a computer for data interfacing, processing and storage; plug-in circuit board slots; and software for data manipulation, measurement and comparison computations; and computer peripherals for data display and printing.
Wherein the edge data processor board plugs into the computer and is comprised of circuitry for interfacing with the timing and digital video signals from the CCD camera, bi-phase signal from the X-axis linear encoder; and run length encoding of edge addresses and end of line into a first-in-first-out memory for buffering the data onto the computer data bus.

17. A system for automatically inspecting a workpiece for the perimeter and holes formed therein, said system comprising of:
an inspection table having a transparent glass surface upon which the workpiece is to be laid;
an etched glass calibration scale located at the edge of the glass surface of the table for sensor scale calibration;
a carriage mounted on rails on the table, which is movable in a first direction; containing a light source, and an optical sensor module, which is movable in a second direction perpendicular to the first;
a CCD camera with an imaging sensor consisting of plurality of CCD photo sensing elements in rows and columns, and an enlarging lens, and a plano-convex lens situated within said optical sensor module;
a computer workstation interfacing with motion control positioning subsystems, providing computer controlled two axis motion control positioning of the carriage in one direction and the optical sensor module in a second direction perpendicular to the first; and
a video edge processor board situated within said computer providing the means for synchronizing the CCD camera and the processing of edge address data computer processing;
wherein the front nodal point of the enlarging lens is positioned at the effective focal point of the plano-convex lens and CCD sensor is positioned so that the viewing angle of each photo-sensing element of the multiple element sensor is perpendicular to the surface of the table and the workpiece;
wherein the carriage is mounted on rails and movable in the first direction with a mechanization driven in a closed loop servo configuration by a servo motor module comprised of a microprocessor, rotary shaft encoder, power amplifier and motor contained within a single modular enclosure;
wherein the carriage is comprised of an upper shelf containing a fluorescent lamp illuminating the top surface of the table and the workpiece in opposing alignment with the optical sensor module mounted on a lower shelf;
wherein the optical sensor module mounted onto rails and movable in the second direction by a mechanization driven in a closed loop servo configuration by a servo motor module comprised of a micro-processor, rotary shaft encoder, power amplifier and motor contained within a single modular enclosure;
wherein the imaging sensor contained with the CCD camera is a time delay integration charged coupled device; comprised of a plurality of rows and columns of photo sensing elements, with the rows aligned perpendicular to the first direction; wherein the motion of the carriage in the first direction is synchronized with the scanning of the imaging sensor so that as the image passes each row of sensor elements, the signal charge generated in the sensor is passed from one row to the next row, with the signals being summed over the plurality of rows before being transferred to a readout shift register; and providing an indication of the location of the edges of the perimeter and holes in the workpiece, relative to the location of the optical sensor and its photo sensing elements as it scans the on the table surface.
wherein the CCD camera is comprised of the CCD sensor and circuitry for timing and synchronization, analog to digital video conversion, and interfacing with the edge data processor board.

18. The inspection system recited in claim 17, wherein the computer workstation is comprised of a computer for data interfacing, processing and storage; plug-in circuit board slots; and software for data manipulation, measurement and comparison computations; and computer peripherals for data display and printing.

19. The inspection system recited in claim 17, wherein the edge data processor board plugs into the computer and is comprised of circuitry for interfacing with the clock, timing and digital video signals from the CCD camera, bi-phase signal from the X-axis linear encoder; and for run length encoding of edge addresses and end of line into a first-in-first-out memory for buffering the data onto the computer data bus.
